(19) United States
(12) Patent Application Publication
(10) Pub. No.: US 2007/0156428 A1
(43) Pub. Date: Jul. 5, 2007

(54) System and method for internally ordering goods and services

(76) Inventors: Karin KBT Brecht-Tillinger, Edingen-Neckarhausen (DE); Rainer RB Baureis, Wiesloch (DE); Galina GP Pacher, Wiesloch (DE); Dieter DW Wrobel, Nussloch (DE); Igor IW Wassiljew, Kronau (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/322,464

(22) Filed: Dec. 30, 2005

(51) Int. Cl. G06Q 99/00

(52) U.S. Cl. 705/1

(57) ABSTRACT

A system and method for ordering goods in a distributed message based business management system uses an internal request business object that identifies parties involved, items, status of items, and identification and administrative information of an internal request. The internal business object includes actions comprising the ability to submit action for the creation of follow-on documents, trigger a check for correctness and completeness of the internal request, and start an approval action that initiates an approval process of the internal request.

### BACKGROUND

Internal requests in organizations for goods and/or services have been automated to some extent in prior systems. Such systems may require users to have an understanding of the purchase orders. Casual users, such as normal employees of a company, were not able to easily use such systems to create purchase orders if they had a specific request for material or services. They were not able to enter all relevant data for purchase orders or internal requisitions, and were not able easily handle complicated navigation of such services.

In some prior applications that were designed to allow casual users to request goods or services, user interfaces, such as electronic shopping carts and code for implementing functions were combined in a same application. Changes to the code or the user interface may have directly affected other parts of the application, requiring their modification.

### SUMMARY

A system and method for ordering goods in a distributed message based business management system uses an internal request business object that identifies parties involved, items, status of items, and identification and administrative information of an internal request. The internal request business object includes actions comprising the ability to submit action for the creation of follow-on documents, trigger a check for correctness and completeness of the internal request, and start an approval action that initiates an approval process of the internal request.

### BRIEF DESCRIPTION OF THE DRAWINGS

FIG. 1 is a block diagram illustrating a context of an internal request business object according to an example embodiment.

FIG. 2 is a block diagram illustrating a software architecture for a local deployment unit according to an example embodiment.

FIGS. 3A, 3B and 3C are diagrams illustrating internal request business object interfaces with other business objects according to an example embodiment.

FIGS. 4A and 4B are diagrams illustrating operation of several different services interfaces to the internal request business object according to an example embodiment.

FIG. 5 is a diagram illustrating interactions between an internal request business object and an in-house requirement business object according to an example embodiment.

FIG. 6 is a diagram illustrating interactions between the internal request business object and a purchase request business object according to an example embodiment.

FIG. 7 is a diagram illustrating interactions between the internal request business object and a goods and services acknowledgment business object according to an example embodiment.

FIG. 8 is a diagram illustrating interactions between the internal request business object and a supplier invoice business object according to an example embodiment.

FIG. 9 is a diagram illustrating the status of item level for final entry and final invoice to create invoice or confirmations automatically according to an example embodiment.

FIG. 10 is a diagram illustrating an internal request business object status and action scheme according to an example embodiment.

FIG. 11 is a block diagram of a typical computer for a logical deployment unit that for executing methods in a distributed message based transaction based system according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions may be implemented in objects with attendant methods. The methods may be implemented in modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

An internal request business object is used for the procurement of materials or services in a distributed message based business management system. In one embodiment, the internal request object is used to create and manage internal requests from employees in a business, and contains identification of the parties involved, the items and their status. Furthermore, it contains identification and administrative information corresponding to the internal request. The internal request object provides the ability of employees to directly request materials and services without the need to understand the processes and formalities used in the creation of purchase orders normally handled by a specialized purchasing department. The internal request object may be used to enable user interface functions to be separately implemented, such as by different objects than the internal request object. Still further, constraints, in the form of business rules may be applied to the internal request object to implement desired constraints on the ability of employees to purchase goods and services directly.

In one embodiment, employees of a company may be enabled to declare the need of materials or services very easily. The internal request object may be used to facilitate the creation of a lean material and service requests. Such materials and services may be selected from a product catalog, product master, or entered directly by a user. Recurrent requirements can be saved in a template for frequent reuse.

Whether a request will be fulfilled via an external procurement process or an internal deliver from stock may be automatically determined by the system based on business rules. Users do not need to enter extensive data fields. Basic data, such as item description and quantity may be sufficient. In an easy example, items are selected from a catalog, and the user is done. They are not forced to handle complicated screens or struggle with complicated navigation concepts.

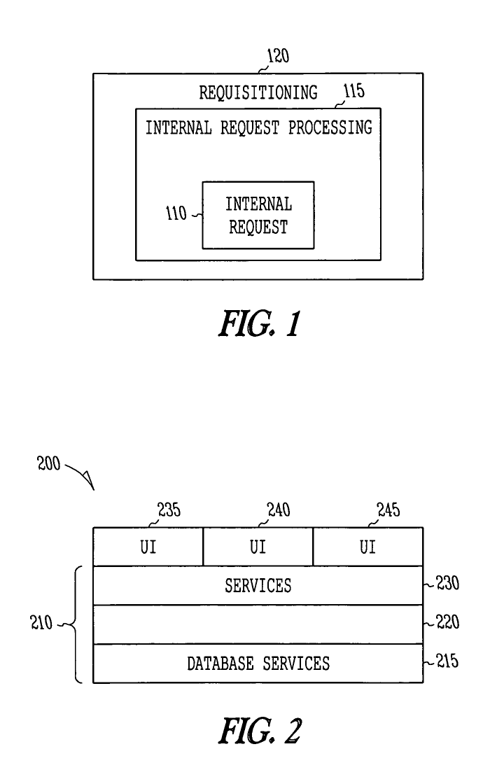

FIG. 1 shows a high level view of an internal request business object 110. The internal request object 110 resides in a process component known as internal request processing 115. The process component is part of a requisitioning deployment unit 120, which may be a implemented in a computer system that is part of a message based distributed business organization computing system.

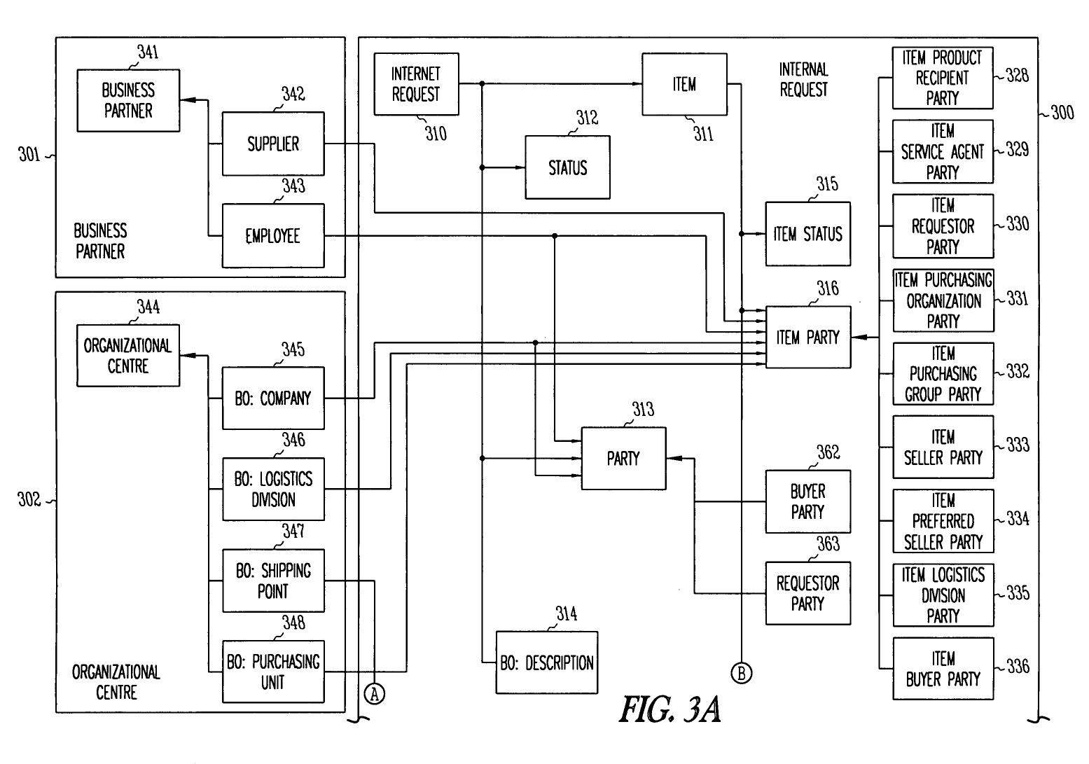

FIG. 2 illustrates a software architecture 200 for a deployment unit 120, of which internal request processing and internal request business objects are a part. Architecture 200 comprises a business process platform 210 consisting of a database services layer 215 that provides access to data related to the business processes implemented locally, and implemented by other deployment units which may be geographically distributed.

An application platform business objects layer 220 comprises multiple business objects which provide business functionality. An internal request business object resides in this layer in one embodiment. Other objects may include purchase order and invoice related objects to name a very few. A services layer 230 provides the ability to retrieve, update, and delete these objects. One or more user interfaces obtain data from the business objects and provide a user interface to users of the system. Such interfaces may be different for different types of users, such as large company users 235, medium size company users 240 and small company users 245. The amount of functionality provided may be varied depending on the type of user. Vertical slices of functionality may be selected for different size companies as well by selecting various components and business objects from a large group of components and objects.

An internal request is a request for the procurement of goods and services. Goods may include materials. A generic term for goods, materials and services may be referred to as items. The internal request may be fulfilled via different objects, such a purchase request or an in-house requirement object. An in-house requirement object is a requirement object that expresses a demand from an internal customer within an organization. A purchase request object expresses a request to a purchasing department to purchase items in specified quantities within a specified time.

Many business functions may be implemented in the internal request object at various levels. The internal request object 110 may implement several functions related to an internal request document. Some of such functions include the ability to create internal request documents manually for the user or for another user. Templates may be created to enable quick creation of requests for frequently requested items. In one embodiment, all users may use templates that have been created. While a user is working on a document, a system check for correctness and completeness of entered data can be triggered to indicate open to-dos. The system may also check an internal request prior to ordering automatically. Incomplete requests may be saved so that a user can return to finish the request at a later time.

In one embodiment, the internal request provides data to enable the display or printing of the internal request. If no follow-on documents exist, it should be possible to modify or delete a request. No further processing of deleted requests should be allowed. Descriptions for internal requests may be entered. Archiving of internal requests that have completed a life cycle may be done. A change history may also be provided for display. Automatic budget checks may also be performed. Internal requests may also deliver data for analytical reporting.

The internal request business object 110 may also implement functions related to approval of an internal request. In one embodiment, an internal request may provide data to enable display of an approval preview, such as who will be responsible approvers. The status of the approval may also be checked. An approval note may also be added by a requester, approver or reviewer. A budget driven approval may also be available, as well as spending limits wherein spending limit controls who will approve which amount. Internal request may also be approved offline, such as from an in box for electronic mail.

In one embodiment, approvers may be added ad-hoc. Approvers may be able to accept, reject, display, and return internal requests. Further, requestors may return internal requests to an approver for reconsideration, and change and display the internal request during the approval process.

In a further embodiment, the internal request is extensible, such as by adding customer fields, transferring added customer fields to follow-on documents and also to offer customers the possibility for individual and modification-free adjustments.

In yet a further embodiment, an internal requests and internal request items may be adjusted to local requirements of different countries and jurisdictions.

Several functions may be implemented by internal request business objects on an item level. These may include things like adding items manually, from a catalog, from internal request templates, from existing internal requests, via copying to add new items which are similar, and deleting items even if follow-on documents exists, provided such documents can be deleted.

Further functions in dealing with items include using items to represent nodes within a hierarchy. Service items for temporary labor may be represented by such a hierarchy. Further, it may be possible add material and service product items. Items may also be added via free text descriptions. Items may be added without specifying an exact price. A maximum limit for service items may be defined, as well as an expected value or flat rate. Limits for expenses for service items and overtime may also be specified. Skill profiles may also be added. Several different catalogs may be used to select items.

Still further functions include the ability to search for existing sources of supply and assigning sources. After a final approval of an internal request, an item may be transferred into a follow-on document, such as a purchase request or in-house requirement. Configuration of which follow-on documents will be created may also be done. Further, a check if material is in stock may be made. A pricing engine in an application platform may be integrated to allow the determination of prices. Integration to a tax engine in the application platform may also be done to determine taxes.

In one embodiment, approvers may reject individual line items in a request containing many items. Approvers may also approve only items for which they are responsible. An acknowledgement may also be posted via an internal request. A supplier invoice may also be posted via the internal request in one step. The internal request may provide data to enable the status of each item and the display of follow-on documents. Additionally, in one embodiment, the internal request may provide data to enable display of change history of items.

Further functions are related to the parties involved with internal requests. The internal request may identify a recipient of the items, a ship-to address, service agents, supplier, preferred supplier, location, purchasing organization, and purchasing group. In addition, in one embodiment, partner schemas may be configured for the internal request which will be forwarded to follow-on documents.

A further set of functions relates to attachments. It may be possible to attach files to an internal request item. Attachments may be added for external use by a supplier. Attachments may be classified to be visible for internal use only. An internal request provides data to enable the display of documents. Attachments may be deleted, and may have versions created. Document management functionality may be used to check in or out a version of an attachment.

Text may also be used in internal requests. It is possible to add descriptions for external use by suppliers or for internal use only. Configurable text may also be stored at an internal request item level, and various schemas may be identified. Text may also be selectively forwarded to follow-on documents.

Some functions relate to account assignment. An account assignment to different accounting objects may be possible for internal request items. For example, cost center, order, fund, funds center, etc., may be assigned. Further the account assignment may be maintained manually. Costs may also be distributed by percentages, quantity or value. Still further the creation of account assignments for multiple line items may be facilitated by copying account assignments and inserting them to and from a clipboard. This may be implemented on top of a user interface platform which is independent from the internal request business object.

Search functions may also be provided for internal requests, such as the ability to search for internal requests and internal request templates. Search criteria may be entered by a user to find such requests and templates.

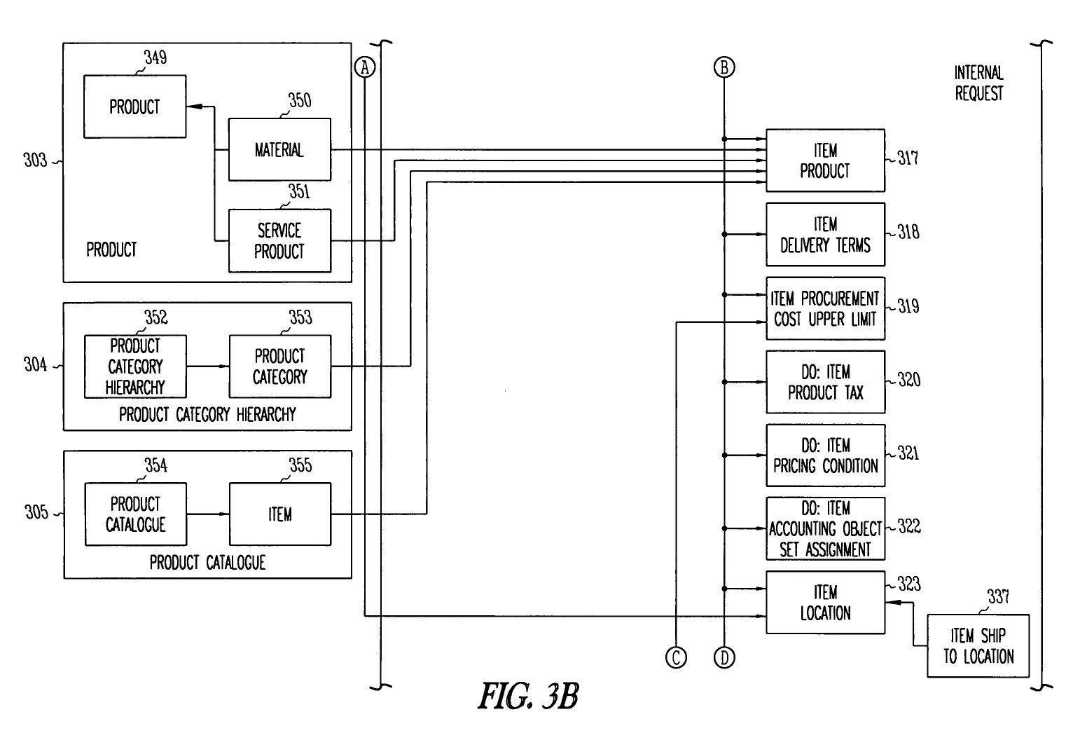

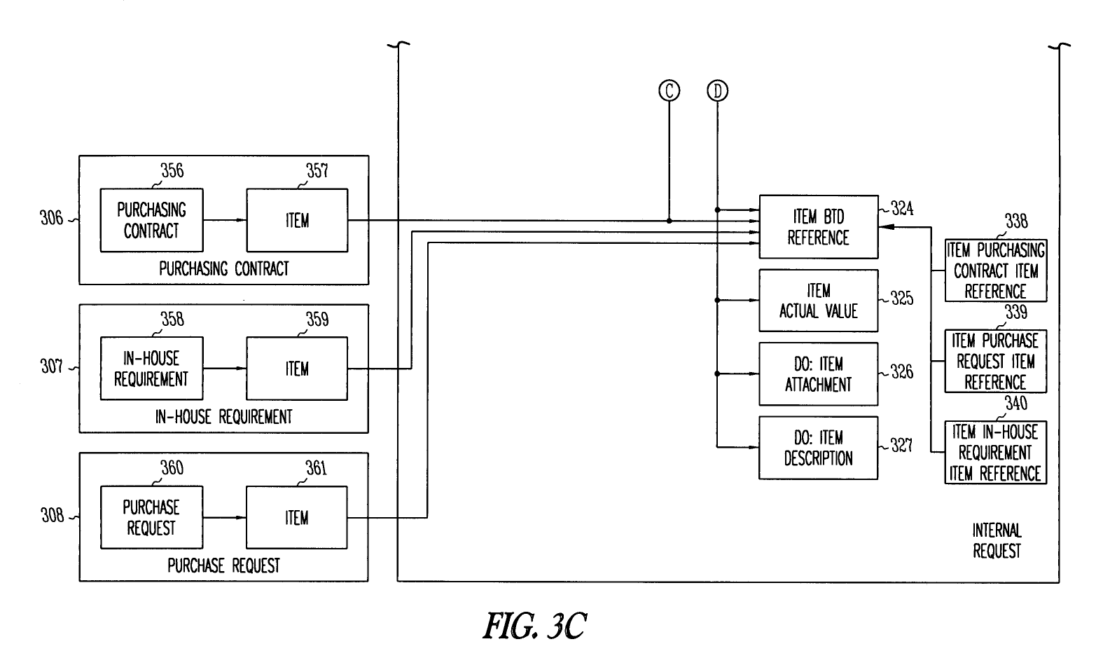

FIGS. 3A, 3B, and 3C illustrate internal request business object relations with other business objects to implement some of the functions described above. An internal request business object is represented at 300, and has relations at least with a business partner object 301, organization center object 302, product object 303, product category hierarchy object 304, product catalogue object 305, purchasing contract object 306, in-house requirement object 307 and purchase request object 308.

Internal request business object 300 includes an internal request 310 includes one or more items 311, a status 312, one or more parties 313 and a description 314. Items 311 is associated with item status 315, item party 316, item product 317, item delivery terms 318, item procurement cost upper limit 319, item product tax 320, item pricing condition 321, item accounting object set assignment 322, item location 323, item reference 324, item actual value 325, item attachment 326 and item description 327.

Item party 316 further comprises item product recipient party 328, item service agent party 329, item requestor party 330, item purchasing organization party 331, item purchasing group party 332, item seller party 333, item preferred seller party 334, item logistical division party 335 and item buyer party 336.

Item location 323 comprises an item ship to location 337. Item reference includes item purchasing contract client reference 338, item purchase request client reference 339 and item in-house requirement client reference 340. Party 313 further comprises buyer party 362 and requestor party 363.

Business partner object 301 comprises a business partner 341, and employee 343. Organizational center object 302 comprises an organizational center 344 which includes several business objects: company 345, logistics division 346, shipping point 347 and purchasing unit 348. Product object 303 includes a product 349, which further includes material 350 and service product 351. Product category hierarchy object 304 comprises a product category hierarchy 352 and product category 353.

Product catalog object 305 includes a product catalog 354 and item 355. Purchasing contract object 306 includes a purchasing contract 356 and item 357. In-house requirement 307 includes an in-house requirement 358 and item 359. Purchase request object 308 includes a purchase request 360 and item 361. There may be relations between some of these objects, such as from product catalog 354 to purchasing contract item 357 and purchase request item 361.

Several lines are drawn between objects 301-308 and the internal request object 300. These lines represent communications between elements in the objects that communicate, invoke functions and transfer data. For instance, product material 350 is coupled to item product 317. An item product (generic) may be represented by a material, a service product, a product category or a catalog item.

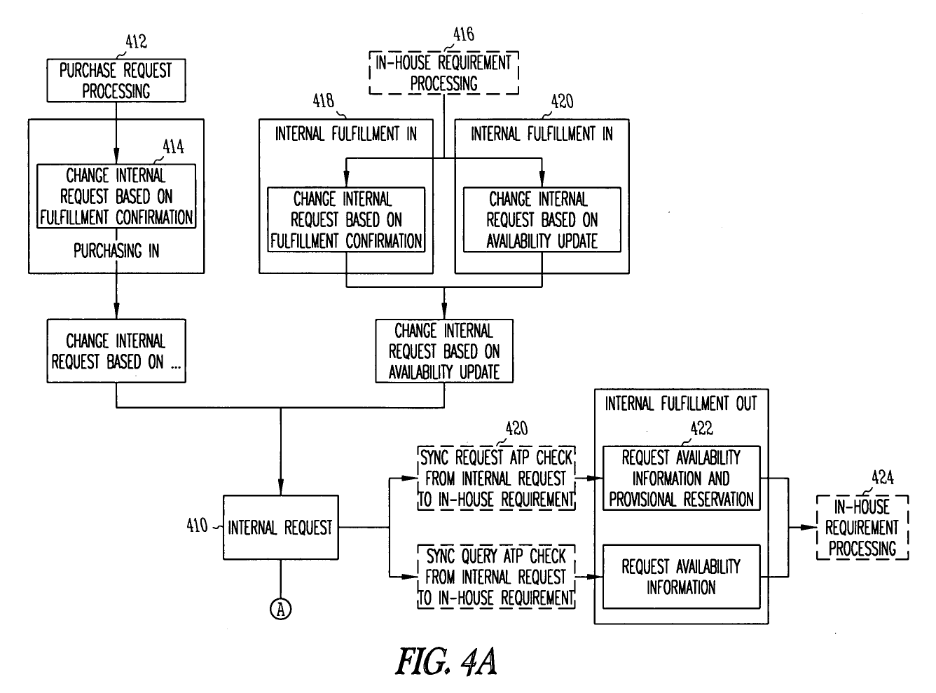

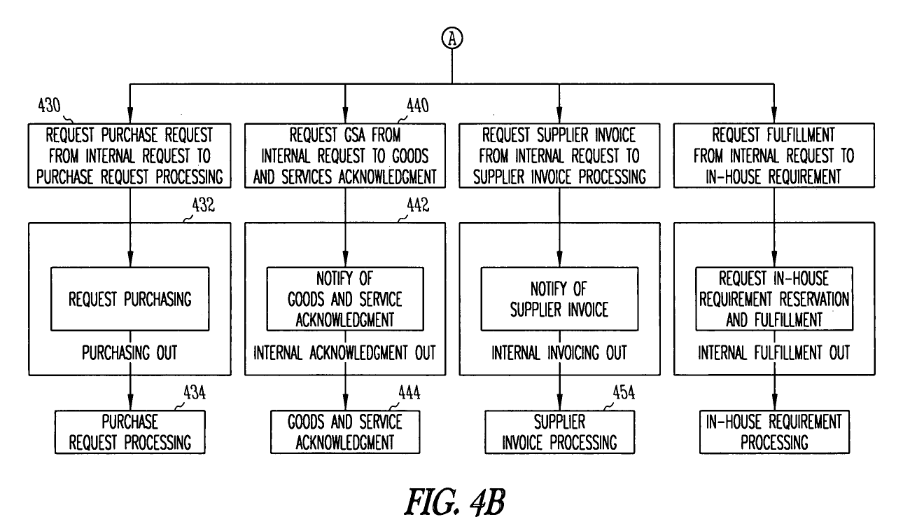

Messages to and from the internal request business object are described with reference to FIGS. 4A and 4B. Purchase request processing 412 may cause a change to the internal request based on procurement progress 414. Further changes may occur as the result of in-house requirement processing 416. Internal fulfillment_in 418 may cause a change to the internal request based on fulfillment confirmation, or based on availability updates at 420.

In one embodiment, an internal request 410 may initiate a synchronous ATP (available to promise) check as indicated at 420. This results in a provisional reservation 422 being sent by internal fulfillment_out being sent to in-house requirement processing 424.

The message change internal request based on procurement progress updates the internal request 410 and gives information about the progress of procurement, meaning changes of follow on documents e.g., the creation of purchase orders 430, the creation of goods and services acknowledgement 440 including the amount of received goods, and the creation of supplier invoices 450. The operation is based on message type purchase request confirmation which is derived from a business object purchase request.

The message request purchasing 432 is sent to a process component 434 that handles the creation of a purchase request

A message notify of goods and services acknowledgement 442 creates a message which is sent to the process component 444 handling creation of a goods and service acknowledgement for delivered goods and rendered services. In one embodiment, a one-click action sends a message of type goods and services acknowledgement notification. This may automatically create a goods and services acknowledgement without manual interaction and therefore helps to streamline organizational processes.

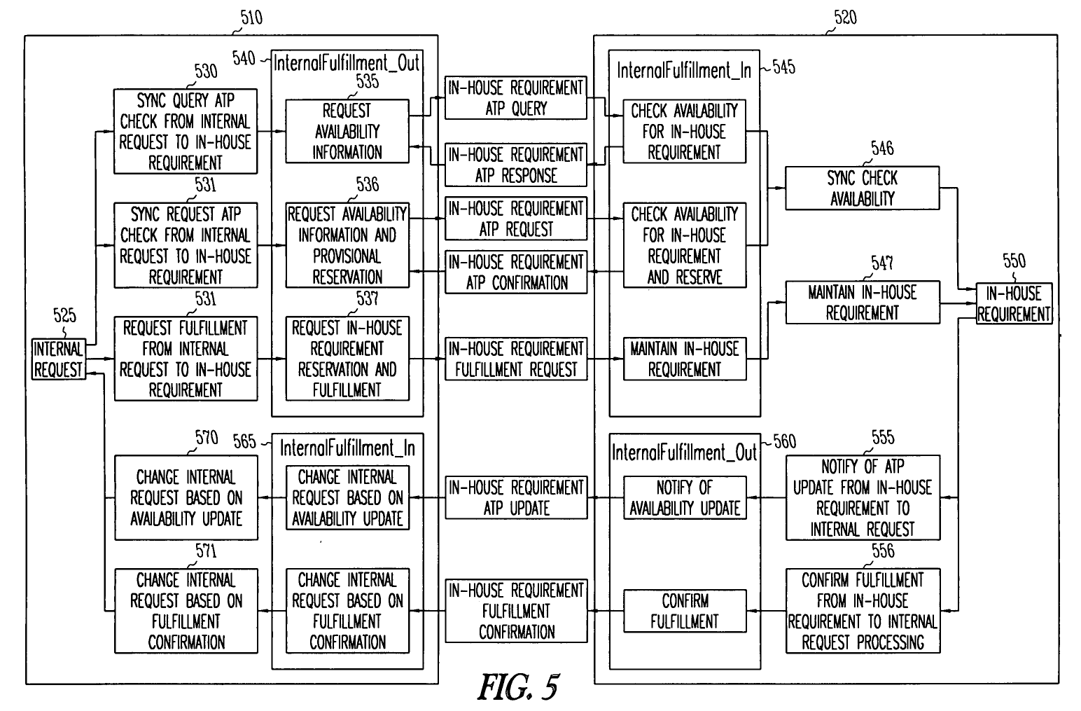

FIG. 5 illustrates interactions between an internal request business object 510 and an in-house requirement business object 520 that may change an internal request 525. Several different requests to in-house requirement may be generated as indicated by sync query 530, sync request 531 and request fulfillment 532. These requests result in the creation of corresponding messages 535, 536 and 537 by internal fulfillment out interface 540, which are sent between the objects and received by an internal fulfillment in interface 545, which results in sync check availability 546 for the sync query and sync request and maintenance of in-house requirements 547 for the fulfillment request. An in-house requirement document is also created at 550.

In house requirements may also notify about updates from the in-house requirement at 555 and confirm fulfillment from in-house requirements at 556. These updates and confirmations are encapsulated in messages via an internal fulfillment out interface 560, and sent to an internal fulfillment in interface 656 in the internal request business object 510, which result in updating of the internal request 525 by a change internal request based on availability update 570 and change internal request based on fulfillment confirmation 572.

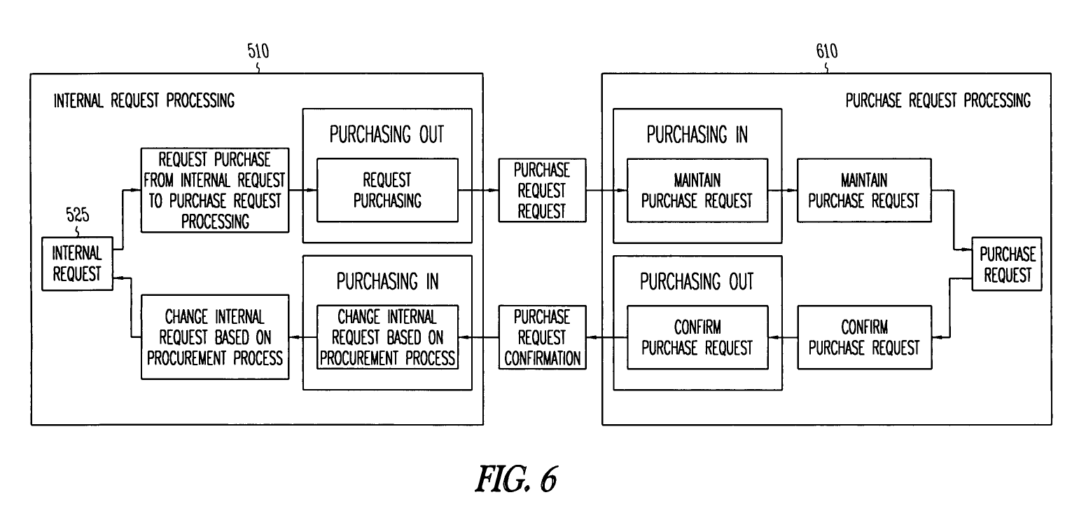

FIG. 6 illustrates interactions between the internal request business object 510 and a purchase request business object 610. It is described which messages are sent and which in- or outbound agents are used to process these messages.

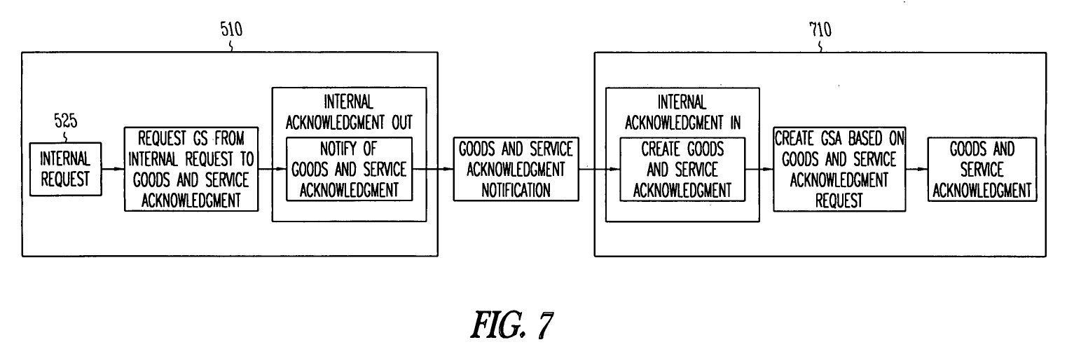

FIG. 7 illustrates interactions between the internal request business object 510 and a goods and services acknowledgment business object 710. It is described which messages are sent and which in- or outbound agents are used to process these messages.

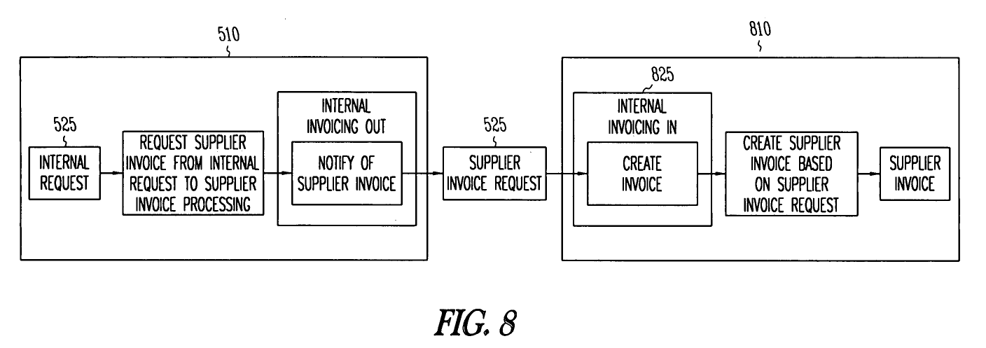

FIG. 8 illustrates interactions between the internal request business object 510 and a supplier invoice business object 810. It is described which messages are sent and which in- or outbound agents are used to process these messages.

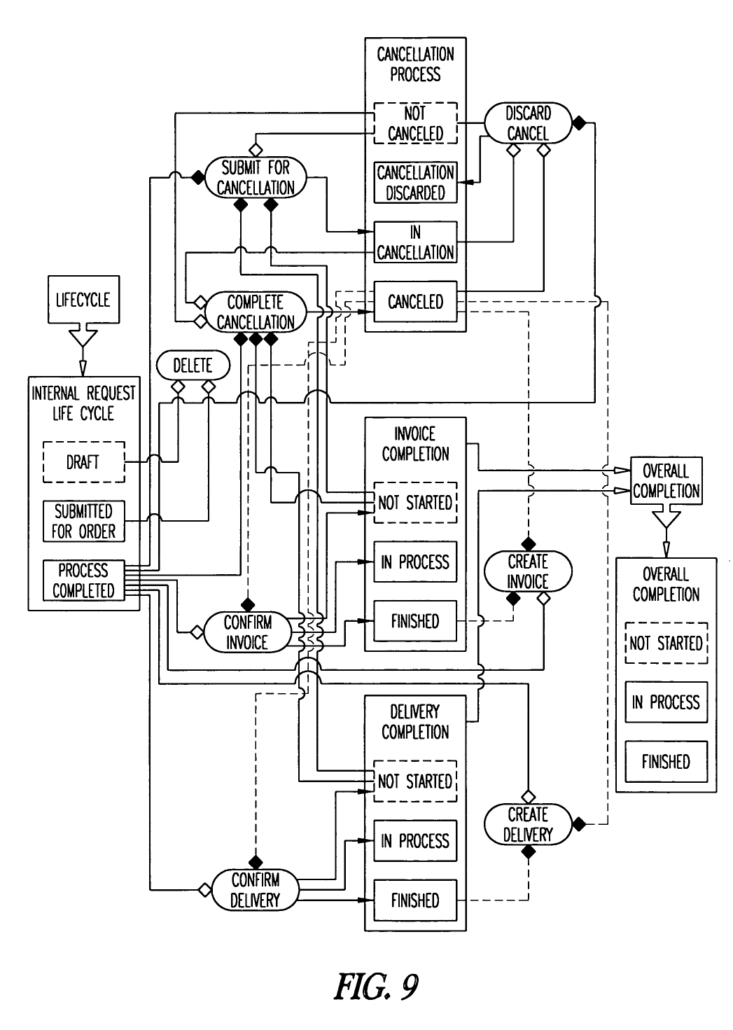

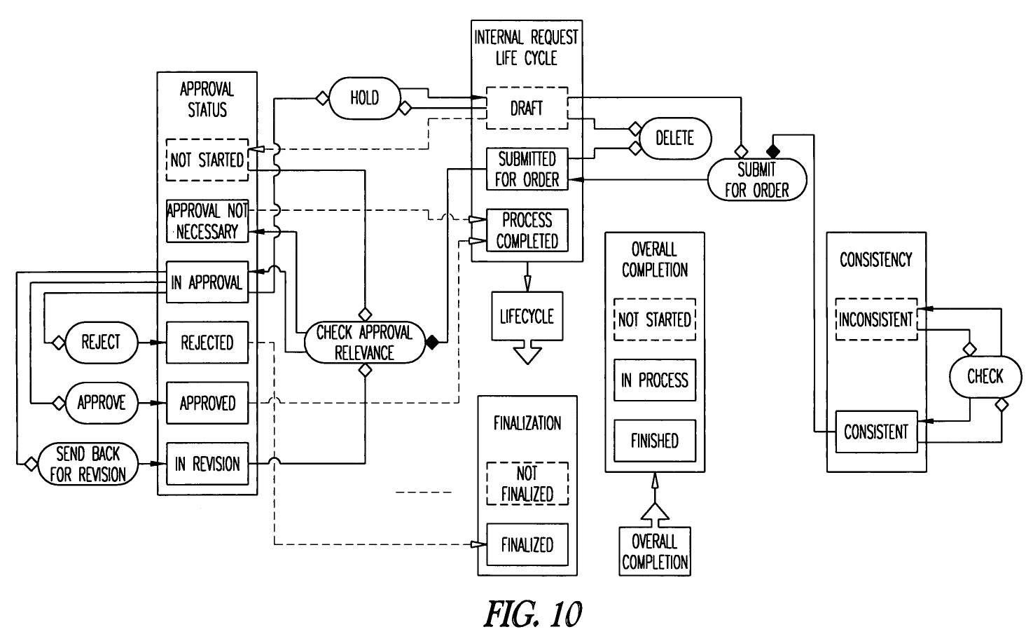

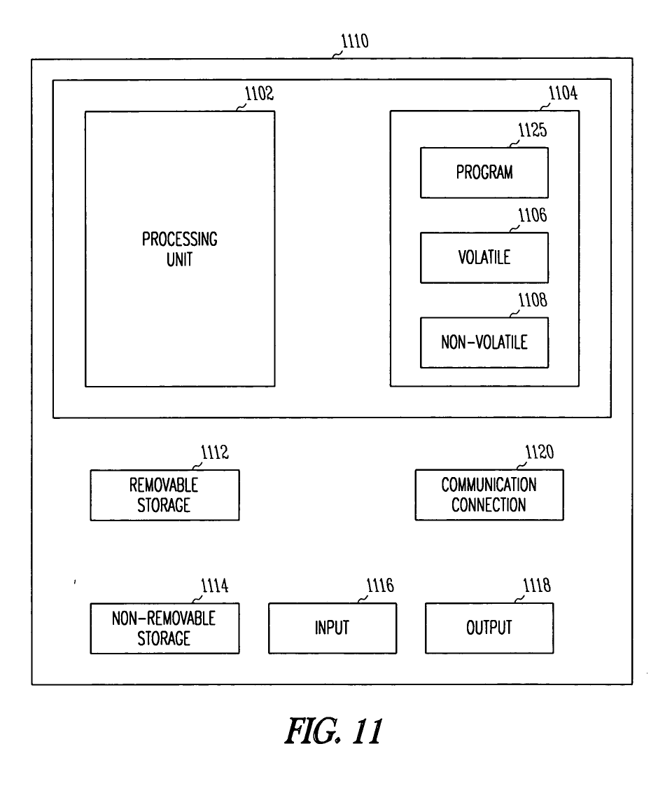

FIG. 9 illustrates an item status model and FIG. 10 illustrates a document status model.

A block diagram of a computer system that executes programming for performing the above functions, such as a local deployment unit, is shown in FIG. 11. In one embodiment, multiple such computer systems are utilized in a message based distributed network to implement multiple components in a transaction based environment. An object oriented architecture may be used to implement such functions and communicate between the multiple systems and components. One example computing device in the form of a computer 1110, may include a processing unit 1102, memory 1104, removable storage 1112, and non-removable storage 1114. Memory 1104 may include volatile memory 1106 and non-volatile memory 1108. Computer 1110 may include—or have access to a computing environment that includes—a variety of computer-readable media, such as volatile memory 1106 and non-volatile memory 1108, removable storage 1112 and non-removable storage 1114. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1110 may include or have access to a computing environment that includes input 1116, output 1118, and a communication connection 1120. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 1102 of the computer 1110. A hard drive, CD-ROM, and RAM are some examples of articles including a computer-readable medium. The term “computer readable medium” is also used to represent carrier waves on which the software is transmitted. For example, a computer program 1125 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 1110 to provide generic access controls in a COM based computer network system having multiple users and servers.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A method of ordering goods and services in a company, the method comprising:
creating an internal request via an internal request business object that identifies information comprising parties involved, items, status of items, and identification and administrative information of the request, wherein the internal request business object includes actions comprising:
submitting the internal request for the creation of follow-on documents;
checking the internal request for correctness and completeness; and
starting an approval action that initiates an approval process of the internal request.

2. The method of claim 1 wherein the actions further comprise approving the internal request when it is accepted.

3. The method of claim 1 wherein the actions further comprise rejecting the internal request when it is declined.

4. The method of claim 1 and further comprising generating state information about a lifecycle of the internal request, and results and prerequisites of processing steps related to the internal request.

5. The method of claim 1 wherein the status describes the status of the internal request after a check process.

6. A system for ordering goods and services in a distributed message based business management system, the system for ordering goods and services comprising:
an internal request business object that identifies information comprising parties involved, items, status of items, and identification and administrative information of an internal request, wherein the internal business object includes actions comprising:
a submit action for the creation of follow-on documents;
check action that triggers a check for correctness and completeness of the internal request; and
a start approval action that initiates an approval process of the internal request.

7. The system of claim 6 wherein the actions further comprise a create template action for the creation of the internal request from a template.

8. The system of claim 6 wherein the actions further comprise an approve action that may be called by an approver if the internal request is accepted.

9. The system of claim 6 and further comprising a rejection action that may be called by an approver to decline the internal request.

10. The system of claim 6 wherein the internal request business object comprises a status function that comprises state information about a lifecycle of the internal request, and results and prerequisites of processing steps related to the internal request.

11. The system of claim 10 wherein the status function includes a completion status element that describes the status of the internal request after a check process.

12. The system of claim 10 wherein the status function includes an approval process status element that describes the state of the internal request in the approval process.

13. The system of claim 6 wherein the internal request business object further includes a check action for completion.

14. The system of claim 6 wherein the internal request business object further comprises actions for the approval process.

15. The system of claim 6 wherein an item is identified by an internal request item that contains elements comprising:
a universal unique identifier;
an ID for identifying the internal request item assigned by a buyer party;
a delivery period;
a quantity;
a gross unit price; and
a tax amount.

16. The system of claim 6 and further comprising a procurement cost upper limit for different types of procurement costs.

17. The system of claim 16 wherein the procurement cost upper limit comprises a type code that is a coded representation of an upper limit type.

18. The system of claim 17 wherein the upper limit types include overall, partial and contract.

19. The system of claim 17 wherein the procurement cost upper limit comprises an amount unlimited indicator that indicates whether the amount is unlimited or not.

20. The system of claim 16 wherein the procurement cost upper limit comprises constraints.

21. The system of claim 20 wherein the constraints are a function of one or more expected amount and upper limit types.

22. The system of claim 6 wherein the internal request has elements comprising:
a universal unique identifier;
an identifier assigned by a buyer party;
a processing type code representing a processing type of the internal request; and
a template indicator indicating whether the internal request is a template.

23. The system of claim 22 wherein the internal request further comprises a currency code element identifying a currency for the internal request.

24. A computer readable medium having code for ordering goods in a distributed message based business management system, the code comprising:
an internal request business object that identifies information comprising parties involved, items, status of items, and identification and administrative information of an internal request, wherein the internal business object includes actions comprising:
a submit action for the creation of follow-on documents;
check action that triggers a check for correctness and completeness; and
a start approval action that initiates an approval process of the internal request.
